(19) United States
(12) Patent Application Publication
(10) Pub. No.: US 2025/0034444 A1
(43) Pub. Date: Jan. 30, 2025

(54) USE OF A NOVEL TYPE OF PROPELLANT FOR ELECTRIC PROPULSION

(71) Applicant: COMMISSARIAT A L'ENERGIE ATOMIQUE ET AUX ENERGIES ALTERNATIVES, Paris (FR)

(72) Inventor: Pascal LEMAIRE, Orange (FR)

(73) Assignee: COMMISSARIAT A L'ENERGIE ATOMIQUE ET AUX ENERGIES ALTERNATIVES, Paris (FR)

(21) Appl. No.: 18/718,964

(22) PCT Filed: Dec. 16, 2022
(86) PCT No.: PCT/FR2022/052397

§ 371 Date: Jun. 12, 2024

(30) Foreign Application Priority Data
Dec. 17, 2021 (FR) FR2113809

(51) Int. Cl. C09K 3/30; C01G 43/06

(52) U.S. Cl. CPC C09K 3/30; C01G 43/063

(57) ABSTRACT

Depleted uranium hexafluoride (UF₆) may be used as a propellant in an electric thruster. An electric thrusters may be propelled with a propellant including such depleted uranium hexafluoride, e.g., in a range of from 0.2 and 0.4% of ²³⁵U. The propelling with such a propellant may be conducted in outer space. The propelling may include producing cations and anions without two distinct propellants. The propelling may include, for example, a changing orbit, reorienting a satellite, interplanetary journeying, and/or avoiding an object in space.

### TECHNICAL FIELD

The invention relates to the use of a novel type of propellant for electric propulsion and, in particular, space electric propulsion.

In general, propulsion relies on the exchange of momentum between an ejected material and the propulsion machine, the ejected material possibly consisting of:
hot gases resulting from an exothermic combustion reaction of a propellant comprising a fuel and an oxidiser, these gases being ejected by expansion at high temperature through a nozzle, this case corresponding to chemical propulsion; or
charged particles from a plasma generated from a propellant, the energy to create the plasma and accelerate the ions of this plasma for an ejection being an energy of electric origin, this case corresponding to electric propulsion.

Electric propulsion, also called plasma propulsion or ion propulsion, allows, thanks to a separation between the energy source and the material to be ejected, reaching a high ejection speed, which thus induces a very low propellant consumption, unlike chemical propulsion. When electric propulsion is used in the space field and, more specifically, in satellite propulsion, it is thus possible to reduce the mass of the propelled satellites and, thus, their launch cost or, moreover, extend the duration of a mission and increase its impact. Thus, despite a low level of thrust and lower than that of chemical propulsion, electric propulsion allows gains in capacity and costs and allows the accomplishment of manoeuvres and missions which would otherwise be difficult to achieve.

Currently, electric propulsion is ensured mainly and operationally by two relatively similar technologies: gridded ion thruster and Hall-effect thrusters, these two technologies differing in the way of generating the electric field at the origin of the ion ejection, the electric field being generated thanks to two biased grids for the gridded ion thruster and being generated by the combination of a magnetic field and an electrostatic potential difference between an anode and a cathode for Hall-effect electric thrusters.

Different types of propellants can be used in these electric thrusters and, in particular:
noble gases, such as xenon which is mainly used or even krypton or argon;
solid propellants, such as diode, magnesium or zinc.

Electric propulsion can also be provided, to date but still at the prototype stage, by propellers called “electronegative thrusters” consisting in using both positive ions and negative ions for thrust, which conventionally requires the management of two propellants, one propellant capable of generating positive ions (for example, argon) and one propellant capable of generating negative ions (for example, sulphur hexafluoride) under a similar pressure, the use of two types of propellant however generating an excess weight which is detrimental to propulsion performance.

In view of what already exists, the inventors of the present invention have set themselves the objective of proposing a new propellant that can be used effectively in the context of electric propulsion and, more particularly, space electric propulsion, by replacing propellants which are already used in this field and, more specifically, which can be used in all types of electric thrusters, in particular in electronegative electric thrusters, without requiring the use of two distinct propellants.

### DISCLOSURE OF THE INVENTION

Thus, the invention relates to the use of depleted uranium hexafluoride UF₆, as propellant in an electric thruster and, more particularly, in a space electric thruster.

The concept of propellant can also be referred to as propellant gas.

Conventionally, depleted uranium hexafluoride corresponds to uranium hexafluoride whose uranium has an isotopic composition including a low abundance of light isotopes, and, more specifically comprised between 0.2 and 0.4% of ²³⁵U, depleted uranium hexafluoride originating, in particular, from spent fuel reprocessing sectors.

Depleted uranium hexafluoride as propellant in electric propulsion has the following advantages:
a vapour pressure with a sublimation limit at near-ambient temperature and pressure;
a much better thrust at fixed power, due to the fact that the gas UF₆ is significantly heavier (352 g/mol) relative to xenon (131 g/mol)
a management by the temperature only of the density of propelled uranium hexafluoride, due to the fact that very stable uranium hexafluoride sublimates at common temperatures, thus allowing its transport in crystallised form and thus no longer involving a management of liquefied or cryogenic gases;
simplified ground tests with a vacuum in the test chamber obtained by cryogenics and not pumping, the management of uranium hexafluoride being well known to those involved in the nuclear fuel cycle;
a much lower cost and a much greater availability than those of xenon, depleted uranium hexafluoride being in particular available via the rejection of isotopic separation plants of fluorinated natural uranium (for example, depleted uranium from George Besse 2 (GBII));
a possibility of use in all types of electric thrusters and in particular in electronegative electric thrusters, due to the fact that uranium hexafluoride is likely to produce both positive ions (in this case, UF₅⁺) and negative ions (in this case, F⁻) during the ionisation process;
the possibility of being used for all types of space flights, except those with strong gravitation and, in particular, for the space flights intended for a change of orbit, a reorientation of a satellite, an interplanetary journey, an avoidance of objects.

The invention will now be described with regard to the following example.

### DESCRIPTION OF A PARTICULAR EMBODIMENT

### Example

A test was successfully carried out, using uranium hexafluoride in a Hall-effect electric thruster with a power in the kilowatt range. Moreover, the particularly high ionisation cross section can accommodate the wide range of powers available from the Hall-effect thrusters on the market.

1. A propellant suitable for an electric thruster, the propellant comprising:
depleted uranium hexafluoride.

2. The propellant of claim 1, wherein the electric thruster is a space electric thruster.

3. The propellant of claim 1, wherein the depleted uranium hexafluoride comprises ²³⁵U in a range of from 0.2 to 0.4 wt. %.

4. The propellant of claim 1, having more thrust at fixed power than xenon propellant.

5. The propellant of claim 1, which does not comprise two distinct propellants.

6. The propellant of claim 1, which does not comprise krypton.

7. The propellant of claim 1, which does not comprise xenon.

8. The propellant of claim 1, which does not comprise xenon or krypton.

9. The propellant of claim 1, which does not comprise diode, magnesium, or zinc.

10. A method of operating an electric thruster, the method comprising:
propelling the electric thruster with a propellant comprising depleted uranium hexafluoride.

11. The method of claim 10, wherein the electric thruster is a space electric thruster.

12. The method of claim 10, wherein the propelling is conducted in outer space.

13. The method of claim 10, wherein the propelling comprises producing cations and anions without two distinct propellants.

14. The method of claim 10, wherein the propelling comprises a changing orbit, reorienting a satellite, interplanetary journeying, and/or avoiding an object in space.
